(19) United States
(12) Patent Application Publication
(10) Pub. No.: US 2015/0200588 A1
(43) Pub. Date: Jul. 16, 2015

(54) LOW-POWER, SELF-BIASING-CAPABLE CHARGE PUMP WITH CURRENT MATCHING CAPABILITIES

(71) Applicant: QUALCOMM Incorporated, San Diego, CA (US)

(72) Inventors: Yuehchun Claire Cheng, San Diego, CA (US); Jan Christian Diffenderfer, Escondido, CA (US); Yu Song, San Diego, CA (US)

(73) Assignee: QUALCOMM Incorporated, San Diego, CA (US)

(21) Appl. No.: 14/157,100

(22) Filed: Jan. 16, 2014

(51) Int. Cl. H02M 3/07

(52) U.S. Cl. CPC H02M 3/07

(57) ABSTRACT

A charge pump is disclosed herein that includes an output node configured to be coupled to a charge storage device configured to store a charge to produce a control voltage based on the charge stored in the charge storage device; a charging circuit configured to provide charge to the charge storage device; a discharging circuit configured to remove charge from the charge storage device; and an amplifier. The amplifier includes an inverting input configured to receive the control voltage from the output node as a first input signal; and, a non-inverting input configured to receive a second input signal including a bias voltage, wherein the amplifier is configured to attempt to match respective levels of the bias voltage and the control voltage when the charge in the charge storage device is changing.

### BACKGROUND

1. Technical Field

The following relates generally to power saving for integrated circuits, and more specifically to a low-power, self-biasing-capable charge pump with current matching capabilities.

2. Background

A phase-locked loop or phase lock loop (PLL) is a control system that generates an output signal having a phase related to a phase of an input signal having a periodic waveform. PLLs are widely employed in computers, radio, telecommunications, and other electronic applications. Conceptually, the PLL may be described as an electronic circuit that includes oscillator such as a variable frequency oscillator that generates a periodic signal, and a phase detector that compares the phase of that periodic signal with the phase of the input signal. Based on the comparison, a phase difference, which also referred to as a phase error, is generated by the phase detector. The PLL adjusts the output of the oscillator to eliminate the phase error, thereby keeping the phases matched. In a closed-ended system, a feedback loop is established by using an output of the PLL, such as the period signal that is output from the oscillator, where that periodic signal is ‘fed back’ toward the input of the PLL in a loop configuration.

In maintaining the synchronization of the input and output phases, a PLL also maintains synchronization of the input and output frequencies. Consequently, a PLL can synchronize signals, track an input frequency, or generate a frequency that is a multiple of the input frequency. These properties are used for computer clock synchronization, demodulation, and generate a stable frequency at multiples of an input frequency (frequency synthesis). Specifically, PLLs can be used to match a particular clock signal; demodulate a communication signal or recover a signal from a noisy communication channel; or synthesize a particular frequency based on a base frequency.

A delay-locked loop (DLL) is a phase-control circuit similar to a PLL, with the main difference being the use of a delay line instead of an oscillator to correct the detected phase error from the phase detector. A DLL can be used to change the phase of a clock signal (i.e., a signal with a periodic waveform), usually to enhance the clock rise-to-data output valid timing characteristics of integrated circuits (such as DRAM devices). DLLs can also be used for clock and data recovery (CDR), where a phase alignment may be made based on an analysis of a data stream that is sent without a clock reference signal.

Because a complete PLL or DLL device can be implemented in a single integrated circuit building block that can be used to create and distribute precisely timed clock pulses in digital logic circuits such as microprocessors, the device is widely used in modern electronic devices, with typical output frequencies from a fraction of a hertz up to many gigahertzes.

Both PLLs and DLLs use charge pumps to convert the phase error determined by the phase detector into a charge, which is injected into a loop filter. The loop filter acts as a charge storage device as well as a low-pass filter. The output of the loop filter is fed to: in the case of a PLL, a voltage controlled oscillator to slow down or speed up the oscillator; or; in the case of a DLL, a voltage controlled delay line to increase or decrease the delay caused by the delay line. For example, the charge pump can increase the charge in the loop filter by providing current to the loop filter. Conversely, the charge pump can decrease the charge in the loop filter by draining current from the loop filter. Consequently, one issue that arises in charge pump design is minimizing of any mismatch between currents that a charge pump can supply and drain in response to the phase detector. Another issue relates to minimizing any charge sharing at the charge pump output.

Although numerous approaches have been taken to address these issues, existing solutions typically require additional complexities in the design and manufacturing of charge pumps. Thus, it would be desirable to be able to improve the efficiency of charge pumps while reducing costs.

### BRIEF DESCRIPTION OF THE DRAWINGS

These and other sample aspects of the disclosure will be described in the detailed description that follow, and in the accompanying drawings, wherein:

FIG. 1 is a block diagram of a generic locked loop generator that may be used to describe aspects of a charge pump configured in accordance with various aspects of a low-power, self-biasing-capable charge pump with current matching capabilities disclosed herein;

FIG. 2 is a block diagram of a conceptual model that may be used to describe issues for charge pump circuit design in implementing a charge pump in a locked loop generator such as the generic locked loop generator of FIG. 1;

FIG. 3 is a circuit diagram of an improved charge pump circuit that may be used in a locked loop generator such as the locked loop generator of FIG. 1, configured in accordance with various aspects of the disclosed approach for implementing a low-power, self-biasing-capable charge pump with current matching capabilities;

FIG. 4 is a circuit diagram that may be used to describe various operational aspects of the improved charge pump circuit of FIG. 3; and

FIGS. 5A-5D are circuit diagrams that show various operational states of the improved charge pump circuit of FIG. 3.

FIG. 6 is a flow diagram that may be used to describe various operational aspects of the low-power, self-biasing-capable charge pump with current matching capabilities disclosed herein.

FIG. 7 is a block diagram conceptually illustrating an example of a system on a chip (SoC) in which a charge pump configured in accordance with one aspect of a disclosed approach for implementing the low-power, self-biasing-capable charge pump with current matching capabilities may be used.

In accordance with common practice, some of the drawings may be simplified for clarity. Thus, the drawings may not depict all of the elements of a given apparatus (e.g., device) or method. Finally, like reference numerals may be used to denote like features throughout the specification and figures.

### SUMMARY

The following presents a simplified summary of one or more aspects of the disclosed approach, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects for implementing a self-biasing capable single amplifier charge pump is disclosed herein. The charge pump includes a gate configured to receive a reference signal, a first plurality of switching transistors configured to receive a first signal and to increase a charge stored in the charge storage device in response thereto; and a second plurality of switching transistors configured to receive a second signal and to decrease the charge stored in the charge storage device in response thereto, wherein a control voltage is generated as an output of the charge pump based on the charge stored in the charge storage device. The charge pump further includes an amplifier having a non-inverting input and an inverting input, and an output; the inverting input being coupled to the control voltage and the non-inverting input receiving a bias voltage, wherein the operational amplifier is configured match the control voltage and the bias voltage such that a rate of increase in charge caused by the charge pump is matched by a rate of decrease in charge caused by the charge pump. The reference signal for the charge pump may be generated by a constant current source, or the charge pump may be self-biased by using the control voltage as the reference signal.

In one aspect, the disclosure provides a charge pump including an output node configured to be coupled to a charge storage device configured to store a charge to produce a control voltage based on the charge stored in the charge storage device; a charging circuit configured to provide charge to the charge storage device; a discharging circuit configured to remove charge from the charge storage device; and an amplifier. The amplifier includes an inverting input configured to receive the control voltage from the output node as a first input signal; and a non-inverting input configured to receive a second input signal comprising a bias voltage, wherein the amplifier is configured to attempt to match respective levels of the bias voltage and the control voltage when the charge in the charge storage device is changing.

In another aspect, the disclosure provides a charge pump including an output node configured to be coupled to a charge storage device configured to store a charge to produce a control voltage based on the charge stored in the charge storage device; a charging circuit configured to provide charge to the charge storage device; and a discharging circuit configured to remove charge from the charge storage device. The charge pump further includes means for comparing a first input signal comprising the control voltage from the output node, and a second input signal comprising a bias voltage; and means for equalizing voltage levels of the bias voltage and the control voltage when the charge in the charge storage device is changing.

In yet another aspect, the disclosure provides a method for operating a charge pump that includes changing a charge in a charge storage device through an output node based on received control signals comprising an UP signal to increase the charge at a charging rate in the charge storage device and a DOWN signal to decrease the charge at a discharging rate in the charge storage device; determining a difference between a non-inverting input and an inverting input in an amplifier of the charge pump based on the change of the charge, wherein the inverting input is coupled to the output node to receive positive feedback from the output node in the form of a control voltage; providing negative feedback to the non-inverting input of the charge pump based on a bias voltage; and operating the amplifier based on the difference between the bias voltage and the control voltage to equalize the charging rate and the discharging rate.

In still yet another aspect, the disclosure provides a timing signal synchronization apparatus having a phase detector configured to determine a difference in timing between a reference timing signal and a feedback timing signal, and generate a first set of signals at a phase detector output if the difference is positive, and a second set of signals at the phase detector output if the difference is negative; a timing signal generator configured to generate a timing signal based on a control voltage; and a charge pump coupled to the phase detector and the timing signal generator. The charge pump includes an output node configured to be coupled to a charge storage device configured to store a charge to produce the control voltage to control the timing signal generator based on the charge stored in the charge storage device; a charging circuit configured to provide charge to the charge storage device when the first set of signals is received from the phase detector output; a discharging circuit configured to remove charge from the charge storage device when the second set of signals is received from the phase detector output; and an amplifier. The amplifier includes an inverting input configured to receive the control voltage from the output node as a first input signal; and a non-inverting input configured to receive a second input signal comprising a bias voltage, wherein the amplifier is configured to attempt to match respective levels of the bias voltage and the control voltage when the charge in the charge storage device is changing.

These and other aspects of the disclosed approach will become more fully understood upon a review of the detailed description, which follows.

### DETAILED DESCRIPTION

In the following description, reference is made to the accompanying drawings in which is shown, by way of illustration, one or more specific approaches in which various aspects of the disclosure may be practiced. Any detailed description of a specific approach is not to be taken in a limiting sense, and the scope of the disclosure is defined only by the appended claims. The description contained herein is intended to describe various aspecuts of the disclosure in sufficient detail to enable those of ordinary skill in the art to practice the claimed scope of the disclosure. Other approaches may be utilized and changes may be made to the disclosed approach without departing from the spirit of the disclosure.

Further, in the following description elements may be described and illustrated in block diagram form in order not to obscure the disclosed approach due to the inclusion of unnecessary detail. Although any delineation or partitioning of logic between various blocks in a block diagram is to be understood to be of a specific implementation, unless specified otherwise herein, any specific implementation shown and described should only be construed as an example and should not be construed as the only way to implement the disclosed approach. Thus, it should be readily apparent to one of ordinary skill in the art that the disclosed approach may be practiced using numerous other delineations or partitioning of logic between various blocks.

One or more of the elements described herein and illustrated in the drawings may be rearranged; combined into a single element; and/or embodied in several elements. These elements may also be referred to herein as modules, circuits, units, components, acts, features, steps, and/or functions. Additional elements may also be included to describe and illustrate, but without departing from the spirit of, the various aspects of the disclosed approach. For example, any element described herein may include multiple instances of that element. These elements may be generically indicated by a numerical designator (e.g., “110”), and specifically indicated by the numerical indicator followed by either an alphabetic designator (e.g., “110a” or “110A”) or a numeric indicator proceeded by a “dash” (e.g., “110-1”). For ease of following the description, element number indicators will for the most part begin with the number of the figure in which the elements are introduced or most fully discussed.

The following description includes examples in order to provide those of ordinary skill in the art with a better understanding of various aspects of the disclosed approach, and is not meant to be limiting of the scope, applicability, or configuration set forth in the claims. Thus, changes may be made in the function and arrangement of the elements discussed without departing from the spirit and limiting scope of the disclosure. Changes to various aspects of the disclosed approach may also omit, substitute, or add various procedures or components as appropriate, while still remaining within the scope of the disclosed approach. For instance, various steps may be added, omitted, combined, and/or even changed in their order during a particular performance of any of the methods described herein. Also, features described with respect to certain aspects may be combined in other aspects.

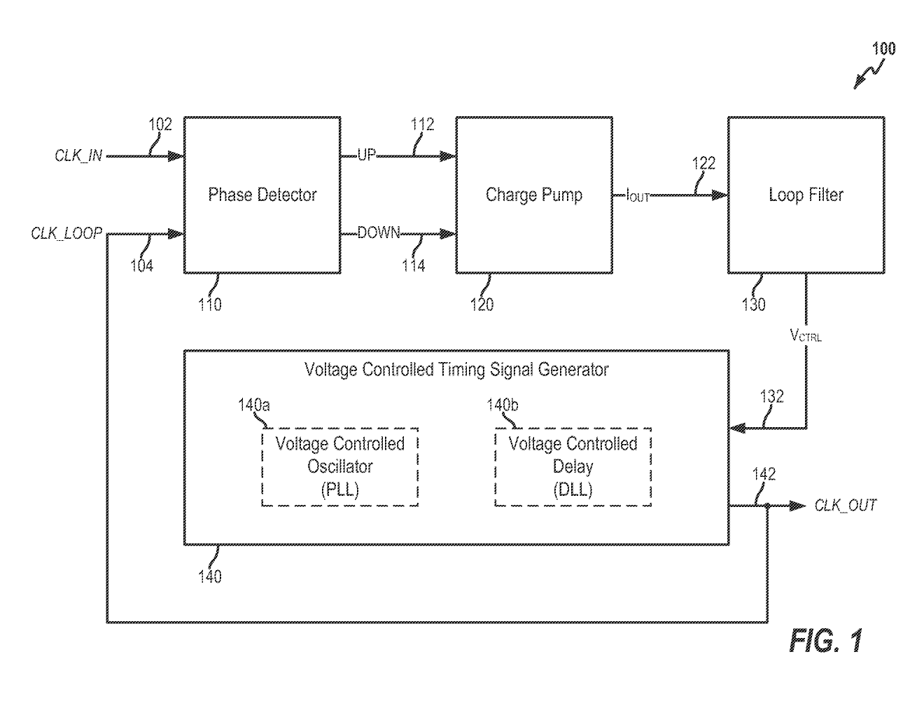

FIG. 1 illustrates a locked loop generator 100 that may be used to describe the operation of charge pumps in the context of a timing signal matching system that includes four main blocks: a phase detector 110, a charge pump 120, a loop filter 130, and a voltage controlled timing signal generator 140. The phase detector 110 is used to detect a phase difference between an input clock received on an input clock signal line, denoted as CLK_IN 102 in the figure, and an output clock signal received on a feedback loop clock signal line, denoted as CLK_LOOP 104 in the figure. The phase detector 110 outputs pulses on an UP signal line, denoted as an UP signal line 112, or a down signal line, denoted as a DOWN signal line 114, to the charge pump 120 based on a phase difference detected by the phase detector 110. For example, if the phase detector 110 detects that the phase of the input clock signal on the CLK_IN 102 signal line is leading the phase of the feedback loop clock signal on the CLK_LOOP 104 signal line, then the phase detector 110 will output a pulse on the UP signal line 112. As used herein, a pulse being output by the phase detector 110 on the UP signal line 112 is referred to as an “UP” signal. Conversely, a pulse being output by the phase detector 110 on the DOWN signal line 114 is referred to a “DOWN” or “DN” signal.

The charge pump 120 includes an output node for a control current signal, denoted as I_{OUT} signal 122 in the figure, that the charge pump 120 may vary based on the pulses received on the UP signal line 112 and the DOWN signal line 114. Specifically, the charge pump 120 may add charge at the output node for UP signals, and remove charge from the output node for DOWN signals. Typically, both UP and DOWN signals will be provided when a desired level at the output node is to be maintained. Although the examples provided herein may describe pulses on the UP signal line 112 or the DOWN signal line 114 to cause the charge pump 120 to provide or remove, respectively, charge at the output of the charge pump 120, conceptually the terms “UP” and “DOWN” may be used to refer to an increase and decrease, respectively; or an decrease and increase, respectively, of charge at the output node due to an operation of the charge pump 120.

To reduce instability from the operation of the charge pump 120, the locked loop generator 100 uses the loop filter 130, which is operatively connected to the charge pump 120 receive the I_{OUT} signal 122 of the charge pump 120, so as to store/dissipate charge based on the control current signal. The loop filter 130 generates a control voltage signal, denoted as V_{CTRL} signal 132 in the figure, based on the current level of charge received from the charge pump 120. The V_{CTRL} signal 132 serves as an input to the voltage controlled timing signal generator 140. The loop filter 130 is typically implemented using a capacitor circuit and the charge pump 120 provides the I_{OUT} signal 122 to add or remove charge from the capacitor circuit.

The voltage controlled timing signal generator 140 produces a timing signal, denoted as CLK_OUT 142, based on the V_{CTRL} signal 132. As FIG. 1 is a generic figure for a locked loop generator that may represent either a PLL or a DLL, the CLK_OUT signal 140 may be generated by either an oscillator or a delay line, respectively. Specifically, the CLK_OUT signal 142 is generated by a voltage controlled oscillator 140a if the locked loop generator 100 is a PLL; or by a voltage controlled delay line 140b if the locked loop generator 100 is a DLL. The CLK_OUT signal 142, in addition to serving as an output of the locked loop generator 100, is fed back to the feedback loop clock signal input of the phase detector 110 on the CLK_LOOP signal line 104.

As discussed above, one challenge in charge pump design is minimization of any mismatch between what currents that a charge pump can both supply and drain in response to a phase detector such as the phase detector 110. For example, any mismatch in characteristics in devices used to implement the charge pump, such as mismatches between P-type and N-type device characteristics will result in current mismatches. Another challenge is minimization of any charge sharing at charge pump output. For example, drain voltage at the current source typically jumps when the current source device is switched.

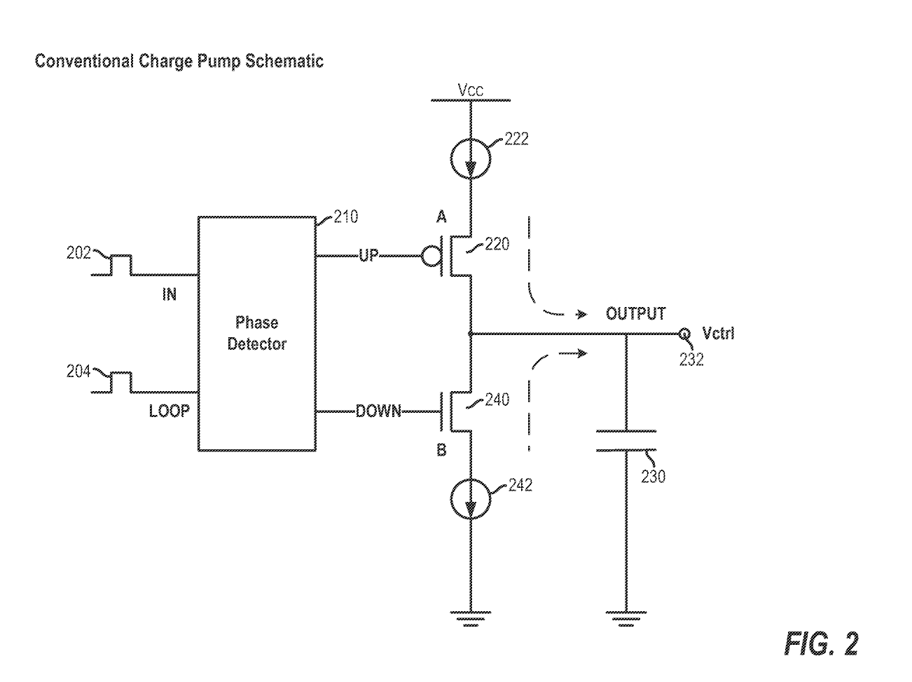

FIG. 2 illustrates a charge pump model 200 that includes a charge pump circuit for describing typical issues encountered in charge pump designs. Conceptually, the charge pump circuit in the charge pump model 200 receives digital signals from a phase detector 210 to control and modify an analog signal level, referred to and illustrated as a control voltage V_{CTRL} that may be used to control an oscillator or delay line (not shown). The charge pump model 200 includes a phase detector 210 that controls two current sources using either UP signals or DOWN signals based on a reference frequency signal received at an IN input 202 and a feedback loop signal received from at an LOOP input 204. An UP signal from the phase detector 210 will switch an UP current switch 220 to allow a current source, referred to and illustrated as a charging current source 222, to provide charge with a current I_{UP} to a charge storage device, referred to and illustrated as a capacitor 230 at an output node 232. Similarly, a DOWN signal from the phase detector 210 will switch a DOWN current switch 240 to allow a current drain, referred to and illustrated as a discharging current source 242, to remove charge with a current I_{DOWN} from the capacitor 230 at the output node 232.

In the charge pump model 200, the two output signals, UP and DOWN, of the phase detector 210 is used to control the two currents, I_{UP} and I_{DOWN}, to charge or discharge the capacitor 230, respectively. The output signals may be used to control two devices to obtain a desired level of V_{CTRL}. In theory, the currents I_{UP} and I_{DOWN} should be equal (matched) such that the capacitor 230 is charged and discharged equally, but in practice these currents are often mismatched. Thus, even given identical UP and DOWN signal inputs, the charge pump circuit will charge and discharge the capacitor 230 at different rates, leading to unequal control output.

As noted above, charge sharing is another issue in charge pump design. Charge sharing is typically caused from parasitic capacitance at the outputs of the current sources. Continuing to refer to FIG. 2, the voltage levels at two nodes A and B are used to describe the charge sharing issue where, when the UP and DN signals are invalid, the voltage level at node A is charged to V_{DD}, and the voltage level at node B is discharged to GND. Conversely, when the UP and DN signals are valid, such as when the phase detector 210 has determined that the loop is locked, the voltage level at node A will be falling and the voltage level at node B level will be rising. As the difference between V_{CTRL} at the output node and node A will not be uniform to the difference between V_{CTRL} at the output node and node B, charge redistribution occurs among the output node, the node A, and the node B. This charge redistribution will result in current mismatch that causes jitter in V_{CTRL}, which is undesirable. Further, the net current generated by the charge pump circuit is not equal to zero because of current mismatch, which will make the level of V_{CTRL} at the output node either increase or decrease a fixed value at every phase compare event, depending on whether the UP current source or the DOWN current source is larger. Preferably, the level of V_{CTRL} at the output node should be held at an average value to maintain the loop in a locked state, where the output would be held relatively constant if the charge and discharge currents are well matched.

Various aspects of the disclosed approach provides a charge pump circuit having current matching and charge sharing suppression features. The charge pump circuit may be used for PLL or DLL applications. While achieving accurate current matching and charge sharing suppression, in one aspect of the disclosed approach the charge pump circuit provides for reduced power consumption, with the fact that only one amplifier is used. In one aspect of the disclosed approach, this charge pump may be configured as a self-biased charge pump circuit where no extra biasing circuits are needed. In the self-biased configuration, the charge pump currents may vary with an oscillator control voltage and used in applications where loop stability has a weak dependency on the magnitude of charge pump current, such as DLLs and single DC-pole PLLs. The charge pump circuit may also be configured as a conventional constant current charge pump.

The various aspects may be described using additional figures. As used herein, an input in any of the figures labeled as an up input refers to an input that receives UP signals and an input in any of the figures labeled as an u̅p̅ input refers to an input that receives an inverse of the UP signals. Similarly, an input in any of the figures labeled as a do input refers to an input that receives DOWN signals and an input in any of the figures labeled as a d̅n̅ input refers to an input that receives an inverse of the DOWN signals.

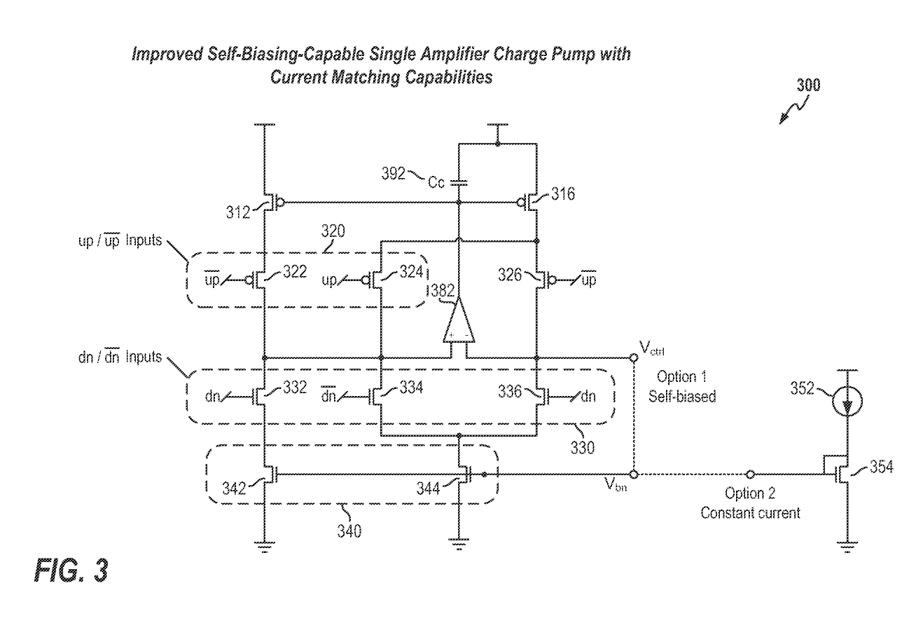

FIG. 3 illustrates an improved charge pump circuit 300 configured in accordance with various aspects of the disclosed approach. The transistors include both types of metal-oxide semiconductor (MOS) transistors: N-type MOS (NMOS) transistors, and P-type MOS (PMOS) transistors. A charge pump configuration as shown by the improved charge pump circuit 300 in FIG. 3 provides both current matching and charge sharing suppression using a single amplifier, an operational amplifier 382. The NMOS transistors 342 and 344 provide a current path 340 to a pull-down circuit 330 that include NMOS transistors 332, 334, and 336, and a pull-up circuit 320 that includes PMOS transistors 322, 324, and 326. In one aspect of the disclosed approach, which is labeled as Option 1 in FIG. 3, a node labeled V_{CTRL} is coupled to the input of the inverting side of the operational amplifier 382, as well as to the gates of NMOS transistors 342 and 344. The current source thus tracks V_{CTRL}, allowing the improved charge pump circuit 300 to be self-biased.

In another aspect of the disclosed approach, which is labeled as Option 2 in FIG. 3, NMOS 374 provides an initial bias voltage V_{bn} based on a current I_{b} supplied by a current source 372 to the gates of NMOS transistors 342 and 344, providing a constant current source to both sides of the circuit. The source of NMOS transistors 332 and 334 are coupled to the drains of PMOS transistors 322 and 324 at the non-inverting side of the operational amplifier 382 and the source of NMOS transistor 336 is coupled to the drain of PMOS transistor 326 at the inverting side of the operational amplifier 382 to achieve the current matching between the transistors.

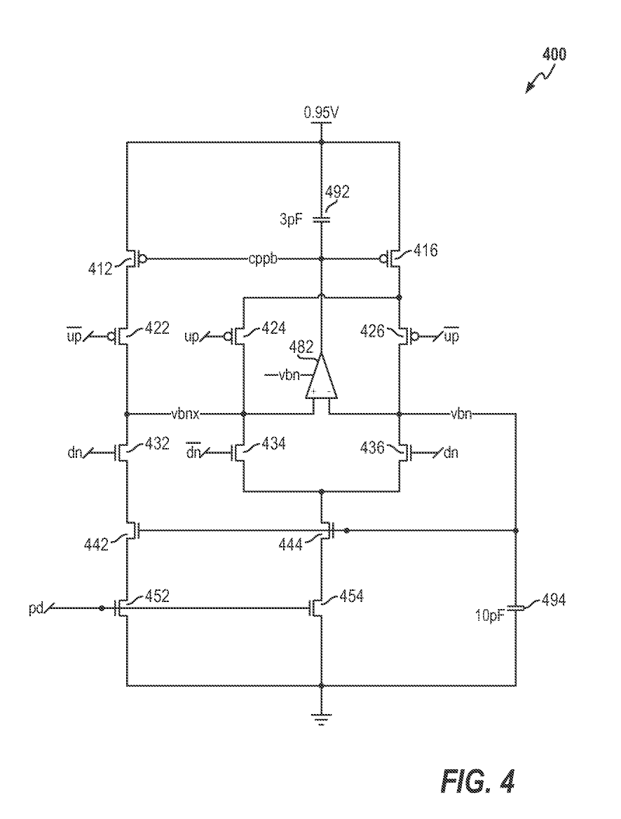

FIG. 4 is a circuit diagram of a charge pump implementation 400 that may be used to describe various operational aspects of the improved charge pump circuit 300 of FIG. 3. During a normal mode of operation, the gates of NMOS transistors 442 and 444 are coupled to a bias voltage V_{bn} across a capacitor 494, creating an initial current for the pull-up/pull-down circuit through NMOS transistors 442 and 444. Further, NMOS transistors 452 and 454 are used to power down (pd) the charge pump implementation 400 when it is not in use.

The source of NMOS transistor 444 is coupled to the drain of NMOS transistor 434 and 436. The drain of NMOS transistor 432 is coupled to the source of NMOS transistor 442. When a DOWN signal is received at the dn input at NMOS transistors 432 and 436, and an inverse of the DOWN signal is a received at the d̅n̅ input at NMOS transistor 434, NMOS transistors 432 and 436 are turned on while NMOS transistor 434, which is coupled to the d̅n̅ input, is off to provide a pull-down current.

The source of PMOS transistor 424 is coupled to the drain of PMOS transistor 416 and the source of PMOS transistor 426. The source of PMOS transistor 422 is coupled to the drain of PMOS transistor 412. The gates of PMOS transistors 412 and 416 are coupled to the output of operational amplifier 482. The gate to source voltage of PMOS transistors 412 and 416 are provided by a capacitor 492, which is coupled to the output of operational amplifier 482 from which it is charged. When an UP signal is applied to PMOS transistors 422, 424, and 426, PMOS transistor 422 and 426 will be on and PMOS transistor 424 will be off.

The inverting input of operational amplifier 482 is coupled to NMOS transistor 436 and PMOS transistor 426 while the non-inverting input of operational amplifier 482 is coupled to NMOS transistor 434 and PMOS transistor 424. The operational amplifier 482 adjusts the voltage between V_{bn} and V_{bnx}. In one aspect of the disclosed approach, the output of operational amplifier 482 is coupled to the gates of PMOS transistors 412 and 416. A change in voltage applied to the gates of the PMOS transistors 412 and 416 results in a corresponding change in voltage on V_{bn} and V_{bnx} through PMOS transistors 422, 424, and 426. Thus, current at the source of NMOS transistors 432, 434, and 436, and the drains of PMOS transistors 422, 424, and 426 are matched. It should be noted that operational amplifier 482 is enabled by V_{bn}.

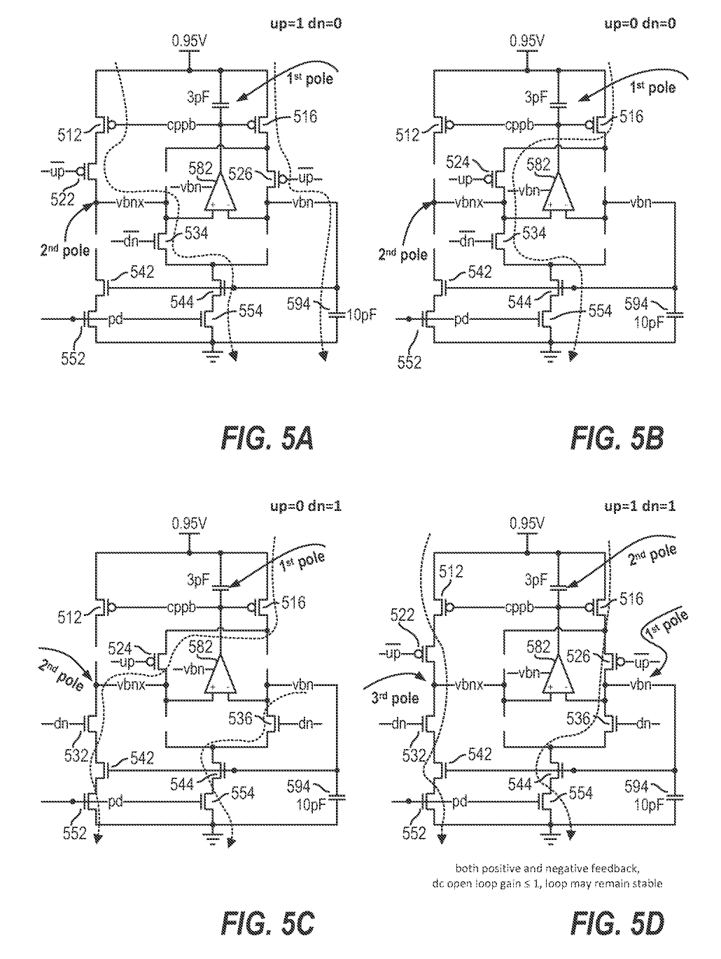

FIGS. 5A-5D each illustrates an operational state of a self-biasing capable single amplifier charge pump of the charge pump implementation 400 described in FIG. 4, based on receiving the following inputs:

| FIG. | UP Input | U̅P̅ Input | DN Input | D̅N̅ Input | V_{CTRL} |
|---|---|---|---|---|---|
| 5A | 1 | 0 | 0 | 1 | Increase |
| 5B | 0 | 1 | 0 | 1 | Hold |
| 5C | 0 | 1 | 1 | 0 | Decrease |
| 5D | 1 | 0 | 1 | 0 | Hold |

where, as shown in Table 1, above, the UP Input refers to an UP signal at an “up” input; the U̅P̅ Input refers to an inverse of the UP signal at an “ u̅p̅” input; the DN Input refers to a DOWN signal at a “dn” input, and the D̅N̅ Input refers to an inverse of the DOWN signal at a “ d̅n̅” input. In addition, the change in V_{CTRL} is described, where “Increase” and “Decrease” means that the level of V_{CTRL} increases or decreases, respectively, and “Hold” means that the level of V_{CTRL} remains relatively stable.

Referring to FIG. 5A, a logical 1 value is received at the up input of the charge pump implementation 400, which means that a logical 0 value is received at the u̅p̅ input. In addition, a logical 0 value is received at the dn input, which means that a logical 1 value is received at the d̅n̅ input. The logical 0 value at the u̅p̅ input turns on PMOS transistors 522 and 526, and the logical 1 value received at the d̅n̅ input turns on NMOS transistor 534. This allows current to flow through PMOS transistors 512 and 522, and NMOS transistors 534, 544, and 554. The current flowing through PMOS transistors 516 and 526 adds charge to capacitor 594, thereby increasing the voltage at V_{bn}. A negative feedback path to the non-inverting input of the operational amplifier 582 is formed through PMOS transistor 512, and NMOS transistors 534, 544, and 554. The operational amplifier 582 thus forces V_{bnx} and V_{bn} to be equal and sets the voltage at the output cppb of the operational amplifier 582 to output a current through PMOS transistors 516 and 526. This current would match the current through NMOS transistor 544, which is set by V_{bn}. In this scenario, V_{CTRL} would increase during the time that PMOS transistors 516 and 526 continuously adds charge to capacitor 594.

Referring to FIG. 5B, a logical 0 value is received at the up input and a logical 0 value is received at the dn input of the charge pump implementation 400 of FIG. 4. The logical 0 value that is received at the up input turns on PMOS transistor 524, and the logical 1 value that is received at the d̅n̅ input turns on NMOS transistor 534. Thus, current flows through PMOS transistor 516 and 524 and NMOS transistors 534, 544, and 554. In this configuration, there is neither an up nor a down output current from the charge pump implementation 400. Thus, V_{CTRL} should remain relatively stable and hold at the existing level.

Referring to FIG. 5C, a logical 0 value is received at the up input, and a logical 1 value is received at the dn input of the charge pump implementation 400 of FIG. 4. The logical 0 value received at the up input turns on PMOS transistor 524, and the logical 1 value received at the dn input turns on NMOS transistor 532. This allows current to flow through PMOS transistors 516 and 524, and NMOS transistor 532, which then flows through NMOS transistors 542 and 552. Further, the logical 1 value received at the dn input turns on NMOS transistor 536. This allows current to flow through NMOS transistor 536, and then through NMOS transistors 544 and 554. The current flowing through NMOS transistors 536, 544, and 554, drains charge away from the capacitor 594. A feedback path into the operational amplifier 582 is formed through PMOS transistors 516 and 524; and NMOS transistors 532, 542, and 552. The operational amplifier 582 thus forces V_{bnx} and V_{bn} to be equal, and sets the voltage on the cppb node to provide a current through PMOS transistors 516 and 524; and NMOS transistors 532, 542, and 552. The output current that flows through NMOS transistor 536 is set by V_{bn}. In this scenario, V_{CTRL} would increase during the time that NMOS transistors 536 and 544 continuously adds charge to capacitor 594.

Referring to FIG. 5D, when a phase detector such as phase detector 110 detects synchronization, the phase detector will send a signal to both the up and dn inputs of the charge pump implementation 400. Thus, a logical 1 value is received at the up input, and a logical 1 value is received at the dn input of the charge pump implementation 400 of FIG. 4. A logical 0 value, which is received at the u̅p̅ input, turns on PMOS transistors 522 and 526, and the logical 1 value received at the dn input turns on NMOS transistors 532 and 536. This allows current to flow through PMOS transistor 512 and 522, and NMOS transistors 534, 544, and 554. A negative feedback path to the operational amplifier 582 is formed through PMOS transistors 512 and 522; and NMOS transistors 532, 542, and 552. In additional, a positive feedback path to the operational amplifier 582 is formed through PMOS transistors 516 and 526; and NMOS transistors 536, 544, and 554. Again, the operational amplifier 582 forces V_{bnx} and V_{bn} to be equal and sets the voltage at the cppb node to output an up current through PMOS transistors 516 and 526. This current would match the current through NMOS transistor 544, which is the active down current set by V_{bn}. Thus, no charge is provided nor removed from the output and effectively the output of V_{CTRL} should remain relatively fixed to maintain a stable locked loop.

In each of the described configurations, there are always feedback paths that keep the operational amplifier functioning so as to force V_{bn} and V_{bnx} to be at the same level and suppress charge sharing issues. Furthermore, the currents generated in response to the UP and DOWN signals are matched as described in each case. In addition, the control voltage at the output node may operate as a self-biasing signal to control the bias voltage of the second input signal.

A charge pump configured in accordance with various aspects of the disclosed approach may include an output node through which a charging circuit may provide charge to a charge storage device and a discharging circuit may remove charge from the charge storage device. A control voltage may thus be generated at the output node based on the charge stored in the charge storage device. Various means may be implemented in the charge pump for providing the features described above. For example, the charge pump may include means for comparing a first input signal that includes the control voltage from the output node, and a second input signal that includes a bias voltage. The means for comparing the first input signal and the second input signal may encompass the amplifier 382 as illustrated in FIG. 3, the amplifier 482 as illustrated in FIG. 4; and the operational amplifier 582 as illustrated in FIGS. 5.

As disclosed herein, the means for comparing the first signal and the second signal such as the amplifier may include an inverting input for receiving the first signal and a non-inverting input for receiving the second signal, wherein the charge pump further includes means for providing a negative feedback path to the non-inverting input. The means for providing the negative feedback path to the non-inverting input may include circuitry as disclosed in FIGS. 3-5A-5D, where, depending on what control signals are received by the charge pump from a device such as a phase detector, an arrangement of various semiconductor devices may be configured such that the non-inverting input of the amplifier may be coupled to receive negative feedback. For example, the charge pump may be configured such that the negative feedback path is configured to carry a current while the charge pump is operational. As another example, the charge pump may include means for equalizing voltage levels of the bias voltage and the control voltage when the charge in the charge storage device is changing. The means for equalizing the voltage levels may include circuitry described with reference to FIGS. 3-5A-D to cause the amplifier to match the two bias voltages V_{bn} and V_{bnx}, where the charging circuit and the discharging circuit are configured to cause the increase and the decrease, respectively, of the charge stored in the charge storage device at an equal rate. Thus, Further, by matching the received at its inputs voltage levels, the amplifier provides means for equalizing the first rate and the second rate.

In various aspects of the disclosed approach, the charging circuit may include means for causing an increase in the charge stored in the charge storage device at a first rate when an UP signal is received. Similarly, the discharging circuit comprises means for causing a decrease in the charge stored in the charge storage device at a second rate when a DOWN signal is received. The means for causing the increase in the charge stored in the charge storage device may include a pull-up circuit as disclosed herein, while the means for causing the decrease in the charge stored in the charge storage device may include a pull-down circuit as disclosed herein. Further, when there is a locked loop and the phase detector signals this by sending both UP and DOWN signals, the charging circuit and the discharging circuit are configured to maintain a level of charge stored in the charge storage device when the charge pump receives both the UP signal and the DOWN signal. Further still, the charge stored in the charge storage device is unchanged by the charging circuit or the discharging circuit when neither the UP signal nor the DOWN signal is received.

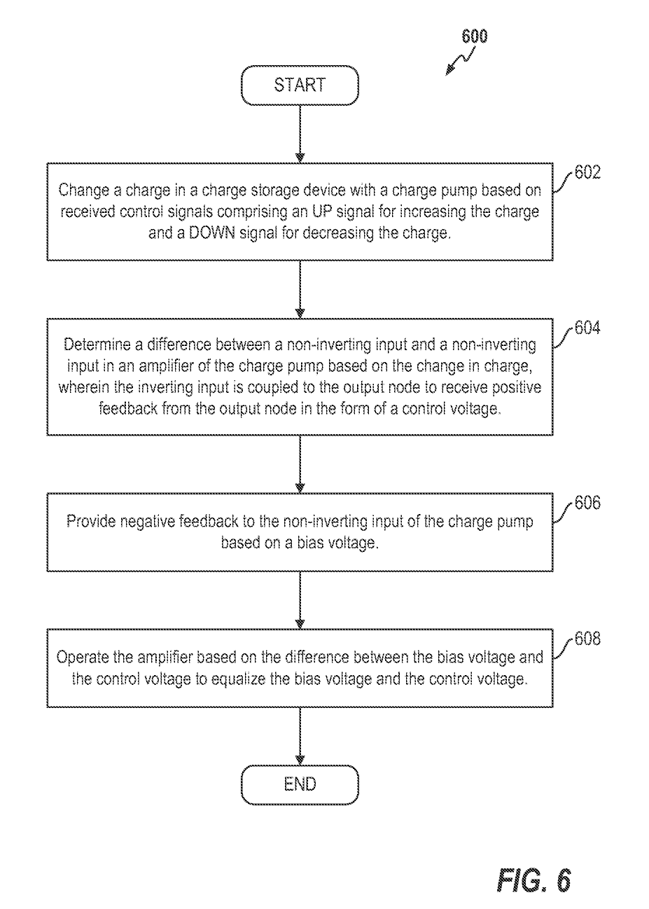

FIG. 6 illustrates a current matching and charge suppression process 600 for a charge pump configured in accordance with various aspects of the low-power, self-biasing-capable charge pump with current matching capabilities disclosed herein, where at 602, a charge in a charge storage device is changed by the charge pump through an output node of the charge pump based on received control signals that includes an UP signal to increase the charge at a charging rate in the charge storage device and a DOWN signal to decrease the charge at a discharging rate in the charge storage device.

At 604, a difference is determined between a non-inverting input and an inverting input in an amplifier of the charge pump based on the change of the charge, wherein the inverting input is coupled to the output node to receive positive feedback from the output node in the form of a control voltage.

At 606, negative feedback is provided to the non-inverting input of the charge pump based on a bias voltage. As disclosed herein, the negative feedback maintains the amplifier and the charge pump in an operating state where the bias voltages are equalized, thereby minimizing charge charging and equalizing the charging and discharging currents.

At 608, the amplifier is operated based on the difference between the bias voltage and the control voltage to equalize the charging rate and the discharging rate. Specifically, based on the difference at its inverting and non-inverting inputs, the amplifier will output a signal that is a function of the difference of signal values between its inputs. Depending on the configuration of the charge pump circuitry, examples of which are described in FIGS. 5A-5D, the rates of charging and discharging of the charge in the charge storage device may be balancing currents flowing therein.

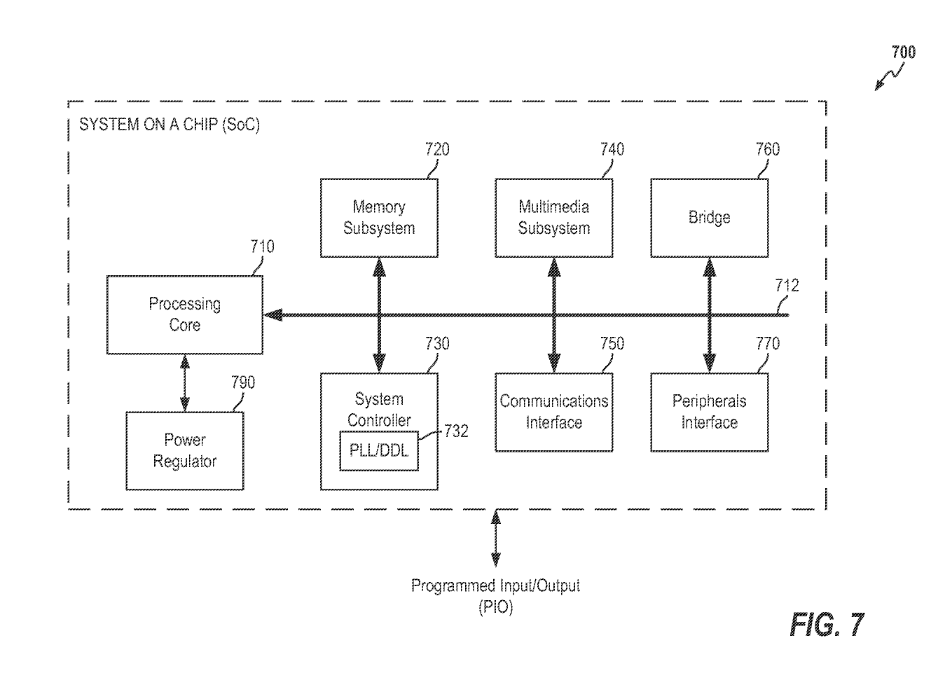

FIG. 7 illustrates a typical system on a chip (SoC) 700 in which various aspects of a charge pump configured in accordance with the disclosed approach for implementing a low-power, self-biasing-capable charge pump with current matching capabilities may be utilized, such as the charge pump implementation 400. The SoC 700 includes a processing core 710 and a memory subsystem 720, supported by a system controller 730 and various other modules, components, and subsystems (referred to generally as subsystems) such as a multimedia subsystem 740, a communications interface 750, and a peripherals interface 770, as further described herein. A bus 712 and a bridge 760 may be included to interconnect the various subsystems in the SoC 700. Further, the SoC 700 also includes a power regulator 790 coupled to the processing core 710 to provide voltage and current regulation for the various subsystems in the SoC 700, as well as a clock 780 that may be used to generate timing signals to distribute for the SoC 700.

In one aspect of the disclosed approach, the SoC 700 may be implemented in a single IC. In another aspect of the disclosed approach, the various modules and subsystems may be implemented as a system-in-package (SiP), in which a number of ICs may be enclosed in a single package, or chip carrier. Thus, the functionality described herein for SoC 700 may also be implemented using multiple ICs in the SiP, but similarly integrated into the single package.

The processing core 710 may include one or more microcontrollers, microprocessors, or digital signal processing (DSP) cores. Depending on the specific requirements for the SoC 700, the processing core 710 may also include field programmable gate arrays (FPGAs), programmable logic devices (PLDs), state machines, gated logic, discrete hardware circuits, and other suitable hardware configured to perform the various functionality described throughout this disclosure.

The system controller 730 may include modules that may be used to provide control and timing for the SoC 700. For example, the system controller 730 may include timing sources that may be used to control and provide timing necessary for operation of various modules and subsystems in the SoC 700. For example, the system controller 730 may include various timers such as real-time clocks for driving timing of operation of various logic; watchdog timers for detecting and initiating recovery from any malfunctions using modules such as a power-on reset (PoR) generators; and counter-timers. To implement these clocks and timers, the system controller 730 may include oscillators and other timing control circuits such as PLL or DDL modules. These PLL or DLL modules may include one or more charge pumps configured in accordance with various aspects of the disclosed approach for implementing a low-power, self-biasing-capable charge pump with current matching capabilities.

The SoC 700 may provide display output for a display (not shown) via the multimedia subsystem 740. The multimedia subsystem 740 may include a graphics processing unit (GPU), video device drivers, and other devices used to produce graphics display information. The multimedia subsystem 740 may also provide for input of multimedia if the SoC 700 is to feature video or image capture functionality from devices such as from a camera or image sensor. In addition to imaging functionality, the multimedia subsystem 740 may also provide for audio processing for both audio input and output. In general, as used herein the multimedia subsystem 740 is an abstraction of a module that handles all multimedia functionality requested of the SoC 700. As mobile devices become more versatile, the multimedia subsystem 740 may be used to provide other functionality.

The communications interface 750 provides an interface between the SoC 700 and external communications interfaces, such as one or more transceivers. The one or more transceivers may conform to one or more communications standards, and provide a means for communicating with various other apparatus over a transmission medium. For example, an external communications interface may include a wireless transceiver with radio frequency (RF) circuitry and components to allow the SoC 700 to communicate on a mobile network. Other external communications interfaces may include transceivers for local area networks (LANs), including wireless LANs (WLANs), and metropolitan or wide area networks (WANs). MAC and PHY layer components may be implemented in the SoC 700 or in one or more communication interfaces.

The memory subsystem 720 may include a selection of memory devices. In one aspect of the disclosed approach, the memory subsystem 720, referred to generally as a computer-readable medium, may be used for storing data that is manipulated by the processing core 710 or other subsystems of the SoC 700 when executing software or algorithms that include instructions to control the operation of the processing core 710 or other subsystems of the SoC 700. These instructions, or “code,” that make up the software or describe various algorithms in the software may themselves be stored in the memory subsystem 720. Although illustrated as being located in the SoC 700, conceptually the memory subsystem 720 as further described herein may include memory components that reside externally to the SoC 700, and distributed across multiple devices or entities. In general, those skilled in the art would understand that it may be more efficient for certain implementations to locate memory components, such as registers, close to other components that may require the functions provided by these memory components most often.

The computer-readable medium may be implemented using computer-readable storage media such as non-transitory computer-readable media. The non-transitory computer-readable media may include, by way of examples, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a removable disk, and any other suitable medium for storing software and/or instructions that may be accessed and read by a processor in a computer or in the processing core 710. The computer-readable medium may also be implemented using other computer-readable media that may include, by way of examples, a carrier wave, a transmission line, and any other suitable medium for transmitting software and/or instructions that may be accessed and read by a processor in a computer or in the processing core 710. The computer-readable medium may be embodied in a computer program product. By way of example, the computer program product may include a computer-readable medium in packaging materials. Those skilled in the art will recognize how best to implement the described functionality presented throughout this disclosure depending on the particular application and the overall design constraints imposed on the overall system.

The peripherals interface 770 may be used to support communications with peripheral devices coupled to the SoC 700 using external interfaces confirming to such industry standards as Universal Serial Bus (USB), FireWire, Universal Synchronous/Asynchronous Receiver/Transmitter (USART), and Serial Peripheral Interface (SPI) busses. The peripherals interface 770 may also include analog interfaces such as digital-to-analog converters (DAC) and analog-to-digital converters (ADC). These peripheral devices may be used to extend the functionality of the SoC 700.

To provide power to the SoC 700, the power regulator 790 may include voltage regulators and power management circuits that interface with power supply components such as one or more power amplifiers, batteries, and converters. In one aspect of the disclosed approach, the power regulator 790 provides power to the SoC 700 based on control information received from the processing core 710. The power regulator 790 may also receive control signals from the system controller 730. Power from the power regulator 790 may be delivered via a power delivery circuit that may include filtering functions. Further, although modern SoCs such as those used in mobile applications include a high level of integration, may designs still dictate that processing and GPU modules operate on their own independent power planes. Thus, the power regulator 790 may also support multiple power planes as necessary.

The SoC 700 may be implemented as having a bus architecture, represented generally by the bus 712 in FIG. 7, and include any number of interconnecting buses and bridges, such as the bridge 760, depending on the specific application of the SoC 700 and overall design constraints. The bus 712 links together the various subsystems of the SoC 700 that, as discussed, may include one or more processors (represented generally by the processing core 710), the memory subsystem 720, and various other subsystems described herein. The bus 712 may include one or more direct memory access (DMA) controllers to route data directly between the memory subsystem 720 and other subsystems, bypassing the processing core 710 and thereby increasing data throughput of the SoC 700.

Those of ordinary skill in the art would understand that the information transmitted, stored, and/or received may be represented using any of a variety of different technologies and techniques. For example, data, instructions, commands, signals, bits, symbols, and chips referenced throughout this description may be represented by voltages, currents, electromagnetic waves, magnetic fields or particles, optical fields or particles, or any combination thereof. Some drawings may illustrate signals as a single signal for clarity of presentation and description. However, it should be understood by those of ordinary skill in the art that the signal may represent several signals, such as those travelling over a signal bus, wherein the signal bus may have a variety of bit widths and the disclosed approach may be implemented using any number of data signals, including a single data signal. For the most part, details concerning timing considerations and the like have been omitted where such details are not necessary to obtain a complete understanding of the disclosed approach, especially by one of ordinary skill in the art.

Those of ordinary skill in the art would appreciate that any of elements described in connection with the various aspects of the disclosed approach may be implemented as electronic hardware (e.g., a digital implementation, an analog implementation, or a combination of the two, which may be designed using source coding or some other technique); various forms of program or design code incorporating instructions, which may be referred to herein, for convenience, as “software” or a “software module”; or combinations of both. To better illustrate this interchangeability of hardware and software, the various illustrative elements have been described above generally in terms of their functionality. Whether such functionality is implemented as hardware or software depends upon the particular application and design constraints imposed on the overall system. Thus, those of ordinary skill in the art may implement the described functionality in varying ways for each particular application, and such implementation decisions should not be interpreted as causing a departure from the spirit of the disclosed approach.

Where any of the elements described herein is implemented as electronic hardware, it may be implemented as either an IC or a part of an IC. The IC may include a general purpose processor, a DSP, an ASIC, an FPGA or other programmable logic device, discrete gate or transistor logic, discrete hardware component, electrical component, optical component, mechanical component, or any combination thereof designed to perform the functions described herein. The general purpose processor may include a microprocessor or, in the alternative, the general purpose processor may be any conventional processor, controller, microcontroller, or state machine. In general, the IC may be configured as a combination of a variety of computing devices described herein, such as a combination of: a DSP and a microprocessor; a number of microprocessors; multiple microprocessors in conjunction with multiple DSPs; or any other such configuration.

To the extent any of the elements described herein is implemented as software that includes algorithmic codes or instructions, those of ordinary skill in the art would appreciate that the various forms of electronic hardware described herein may be configured to operate using said software. For example, an IC may be configured to execute software that reside within the IC, outside of the IC, or both. As another, more specific example, an IC may implement a general purpose processor configured for executing software to perform the functions and operations described herein. As such, those of ordinary skill in the art should understand that any specific order or hierarchy of steps in any disclosed software operation executed by the general purpose processor is an example of a sample approach. Based upon design preferences, it may be preferable to utilize a special purpose processor to carry out various aspects of the disclosed approach. The accompanying method claims thus may include elements of the various steps in a sample order, and are not meant to be limited to the specific order or hierarchy presented unless otherwise stated.

The steps of a method or algorithm described in connection with the various aspects of the disclosed approach may be embodied directly in hardware, in a software module executed by a processor, or in a combination of the two. A software module (e.g., including executable instructions and related data), and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which is referred to herein, for convenience, as a “processor”) such that the processor can both read information (e.g., code) from, and write information to, the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes (e.g., executable by at least one computer) relating to one or more of the aspects of the disclosure. In some aspects a computer program product may comprise packaging materials.

It should be understood that any references that has been made to elements using a designation such as “first,” “second,” “third,” and so forth should not limit a quantity and/or order of those elements, unless any such limitation has been explicitly stated. Rather, these designations should be understood, as convention dictates, to distinguish between two or more elements and/or instances of an element. Thus, a reference to “first and second elements” does not mean that only two elements may be employed nor that the “first element” must precede the “second element” in some manner. In addition, unless stated otherwise, any reference to a “set of elements” should be understood to mean a collection of elements, which may mean an “empty set” where the collection includes zero elements.

The previous description is provided to enable any person skilled in the art to fully understand the full scope of the disclosure. Modifications to any configuration disclosed herein that remains in the spirit of the disclosed approach should be readily apparent to those of ordinary skill in the art. Thus, the claims are not intended to be limited to the specifics of the various aspects of the disclosure described herein, but are to be accorded the full scope consistent with the language of claims, wherein reference to an element in the singular is not intended to mean “one and only one” unless specifically so stated, but rather “one or more.” Unless specifically stated otherwise, the term “some” refers to one or more. A claim that recites at least one of a combination of elements (e.g., “at least one of A, B, or C”) refers to one or more of the recited elements (e.g., A, or B, or C, or any combination thereof). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A charge pump comprising:
an output node configured to be coupled to a charge storage device configured to store a charge to produce a control voltage based on the charge stored in the charge storage device;
a charging circuit configured to provide charge to the charge storage device;
a discharging circuit configured to remove charge from the charge storage device; and
an amplifier comprising:
an inverting input configured to receive the control voltage from the output node as a first input signal; and,
a non-inverting input configured to receive a second input signal comprising a bias voltage,
wherein the amplifier is configured to attempt to match respective levels of the bias voltage and the control voltage when the charge in the charge storage device is changing.

2. The charge pump of claim 1, wherein the charging circuit and the discharging circuit are configured to cause an increase and a decrease, respectively, of the charge stored in the charge storage device at an equal rate.

3. The charge pump of claim 1, wherein the charging circuit and the discharging circuit are configured to maintain a level of charge stored in the charge storage device when both the UP signal and the DOWN signal are received.

4. The charge pump of claim 1, wherein:
the charging circuit comprises a first plurality of switching transistors configured to cause an increase in the charge stored in the charge storage device at a first rate when an UP signal is received;
the discharging circuit comprises a second plurality of switching transistors configured to cause a decrease in the charge stored in the charge storage device at a second rate when a DOWN signal is received; and
the amplifier is configured to equalize the first rate and the second rate.

5. The charge pump of claim 1, wherein the control voltage at the output node operates as a self-biasing signal to control the bias voltage of the second input signal.

6. The charge pump of claim 1, further comprising a negative feedback path to the non-inverting input of the amplifier configured to be active while the charge pump is operational.

7. The charge pump of claim 6, wherein the negative feedback path is configured to carry a current while the charge pump is operational.

8. The charge pump of claim 1, wherein the charge stored in the charge storage device is unchanged by the first plurality of switching transistors and the second plurality of switching transistors when neither the UP signal nor the DOWN signal is received.

9. A charge pump comprising:
an output node configured to be coupled to a charge storage device configured to store a charge to produce a control voltage based on the charge stored in the charge storage device;
a charging circuit configured to provide charge to the charge storage device;
a discharging circuit configured to remove charge from the charge storage device;
means for comparing a first input signal comprising the control voltage from the output node, and a second input signal comprising a bias voltage; and,
means for equalizing voltage levels of the bias voltage and the control voltage when the charge in the charge storage device is changing.

10. The charge pump of claim 9, wherein the charging circuit and the discharging circuit are configured to cause an increase and an decrease, respectively, of the charge stored in the charge storage device at an equal rate.

11. The charge pump of claim 9, wherein the charging circuit and the discharging circuit are configured to maintain a level of charge stored in the charge storage device when both the UP signal and the DOWN signal are received.

12. The charge pump of claim 9, wherein:
the charging circuit comprises means for causing an increase in the charge stored in the charge storage device at a first rate when an UP signal is received;
the discharging circuit comprises means for causing a decrease in the charge stored in the charge storage device at a second rate when a DOWN signal is received; and
the means for equalizing the voltage levels comprises means for equalizing the first rate and the second rate.

13. The charge pump of claim 9, wherein the control voltage at the output node operates as a self-biasing signal to control the bias voltage of the second input signal.

14. The charge pump of claim 9, wherein the means for comparing the first signal and the second signal comprises an inverting input for receiving the first signal and a non-inverting input for receiving the second signal, wherein the charge pump further comprises means for providing a negative feedback path to the non-inverting input.

15. The charge pump of claim 14, wherein the negative feedback path is configured to carry a current while the charge pump is operational.

16. The charge pump of claim 9, wherein the charge stored in the charge storage device is unchanged by the charging circuit and the discharging circuit when neither the UP signal nor the DOWN signal is received.

17. A method for operating a charge pump comprising:
changing a charge in a charge storage device through an output node based on received control signals comprising an UP signal to increase the charge at a charging rate in the charge storage device and a DOWN signal to decrease the charge at a discharging rate in the charge storage device;
determining a difference between a non-inverting input and an inverting input in an amplifier of the charge pump based on the change of the charge, wherein the inverting input is coupled to the output node to receive positive feedback from the output node in a form of a control voltage;
providing negative feedback to the non-inverting input of the charge pump based on a bias voltage; and,
operating the amplifier based on the difference between the bias voltage and the control voltage to equalize the charging rate and the discharging rate.

18. The method of claim 17, wherein operating the amplifier based on the difference between the bias voltage at the non-inverting input of the amplifier and the control voltage at the inverting input of the amplifier comprises equalizing the bias voltage and the control voltage.

19. The method of claim 18, wherein the equalization of the bias voltage and the control voltage comprises activating a plurality of switching transistors to establish a negative feedback path to the non-inverting input.
